(19) United States
(12) Patent Application Publication
(10) Pub. No.: US 2017/0105444 A1
(43) Pub. Date: Apr. 20, 2017

(54) DELIVERY MODE SPECIFIC SYNTHETIC NUTRITIONAL COMPOSITIONS AND NUTRITIONAL SYSTEMS COMPRISING THEM

(71) Applicant: NESTEC S.A., Vevey (CH)

(72) Inventors: Sagar Thakkar, St. Legier (CH); Gerard Vine Pares, Masies de Roda Barcelona (ES)

(21) Appl. No.: 15/312,100

(22) PCT Filed: May 20, 2015
(86) PCT No.: PCT/CN2015/079371

§ 371 Date: Nov. 17, 2016

(30) Foreign Application Priority Data
May 20, 2014 (CN) PCT/CN2014/077881

(51) Int. Cl. A23L 33/16; A23L 33/00; A23C 9/20

(52) U.S. Cl. CPC A23L 33/16; A23C 9/206; A23L 33/40; A23V 2002/00

(57) ABSTRACT

Delivery mode specific synthetic nutritional compositions for infants up to 1 month of age, more particularly up to 2 weeks of age, wherein the iodine content is adapted based on that found in HM produced for an infant of the same age born by the same delivery mode. Nutritional systems comprising said delivery mode specific synthetic nutritional compositions are also provided.

### TECHNICAL FIELD

The invention relates to delivery mode specific synthetic nutritional compositions, to nutritional systems comprising them and, to their use to provide optimised nutrition and/or one or more health benefit to an infant.

### BACKGROUND OF THE INVENTION

Even though breastfeeding is optimal for infants, existence of certain conditions may not be in the best interests of the infant and it may contraindicate breastfeeding (AAP, 2012; Lawrence, 2013). In such cases, where the sole source of nutrition is not available to the infant, alternative strategies to feed them have to be devised. Feeding infants with Synthetic nutritional compositions e.g. Infant formula is one such strategy.

The compositions of the aforementioned synthetic nutritional compositions aim to replicate those of human milk (hereinafter HM). However, replicating HM is not a simple task. HM not only contain numerous components, its composition is extremely dynamic and these dynamic changes remain largely unexplored and uncharacterized. Whilst it is known that components and/or their quantities may vary depending on a variety of factors, it is not known which of the numerous components vary and if so how they vary e.g. what factors they depend upon.

Surprisingly it has now been identified that up to 1 month, more particularly up to 2 weeks, postpartum, there is a difference in the iodine concentration range found in HM produced by mothers to infants born by caesarian section (hereinafter C-section) and mothers to infants born by vaginal delivery. This finding stems from a cross-sectional study of HM wherein, HM samples from mothers to either infants born by C-section or vaginal delivery were collected at various stages postpartum and analysed. Further, it was also surprisingly found that up to 1 month, more particularly up to 2 weeks, postpartum, the mean iodine concentration of HM produced by mothers to infants born by C-section was higher than that produced by mothers to infants born by vaginal delivery.

Because this difference in the iodine concentration in HM up to 1 month, more particularly up to 2 weeks, postpartum has never been previously identified, it is not reflected in the compositions of synthetic nutritional compositions available today.

Iodine is required by the body to synthesise thyroid hormones. An optimum intake of iodine can help to ensure optimum growth and development in infants through optimization of the metabolic rate and prevention of goiter, hypothyroidism and hyperthyroidism, which can all result from a non optimal iodine intake i.e. too much or too little. Hypothyroidism can cause lethargy and weight gain. It can also delay the growth and intellectual development of an infant. In severe cases hypothyroidism can cause cretinism. Hyperthyroidism can cause nervousness, irritability, increased perspiration, heart racing, hand tremors, anxiety, difficulty sleeping, thinning of the skin, fine brittle hair, muscular weakness and weight loss.

Optimum growth and development may be immediate and/or long term. Long term may only be evident in months or years e.g. 6 months, 9 months, 12 months, 5 years, 10 years, or 20 years.

Accordingly, there remains a need for delivery mode specific e.g. C-section or vaginal delivery specific, synthetic nutritional compositions, and nutritional systems comprising them, having compositions within which the identified delivery mode differences, with respect to the iodine concentration, found in HM up to 1 month, more particularly up to 2 weeks, postpartum are more accurately reflected and thereby optimised.

### SUMMARY OF THE INVENTION

The invention is set out in the claims. The inventors have found that the Iodine concentration range in HM varies up to 1 month, more particularly up to 2 weeks, postpartum depending on the delivery mode of the mother's infant i.e. C-section or vaginal delivery . In light of this finding the inventors have developed delivery mode specific nutritional compositions, and nutritional systems comprising them, that reflect this identified delivery mode difference. Prior to aforementioned findings the skilled person has not incentive to develop such delivery mode specific synthetic nutritional compositions, or to include them in nutritional systems.

The iodine concentration in the delivery mode specific synthetic nutritional compositions of the invention, and nutritional systems comprising them, more accurately reflects the iodine concentration in HM produced for infants born by the same delivery mode i.e. by C-section or vaginal delivery. In light of this and, because HM is considered optimal with respect to infant nutrition, these delivery mode specific compositions, and the nutritional systems comprising them, can provide an optimized amount of iodine to an infant of up to 1 month of age, more particularly up to 2 weeks of age.

The delivery mode specific synthetic nutritional compositions can be prepared from a delivery mode neutral synthetic nutritional composition by measuring out an appropriate amount of said delivery mode neutral synthetic nutritional composition and mixing it with an additive and or diluent.

Since an optimised iodine intake can help to ensure the optimum growth and development of an infant, the delivery mode specific synthetic nutritional compositions of the invention, and nutritional systems comprising them, can be used to treat, prevent or mitigate sub optimal growth e.g. obesity of an infant.

The delivery mode specific synthetic nutritional composition is selected from the group consisting of: infant formula, HM fortifier, and a composition for infants that is intended to be added or diluted to human milk e.g. HM fortifier.

In addition to that set out above, the inventors have also found that the mean iodine concentration in HM does not vary by delivery mode i.e. whether the mother's infant has been born by C-section or vaginal delivery, 1 month or later postpartum, more particularly after 2 weeks postpartum. In light of this, in addition to comprising the delivery mode specific synthetic nutritional compositions of the invention, the nutritional systems disclosed herein may optionally also comprise synthetic nutritional compositions for infants more than 1 month of age, more particularly more than 2 weeks of age, wherein, the iodine concentration does not differ by delivery mode for infants of the same age. Accordingly, the nutritional systems of the invention may also provide optimized nutrition and/or be used to treat, prevent or mitigate sub optimal growth e.g. obesity of an infant up to 12, 9, 8, 6, 4, 2 and 1 months of age.

### DETAILED DESCRIPTION

As stated herein, the inventors performed a cross sectional study evaluating the nutrient composition of HM collected from mothers at various stages of lactation (up to 2 weeks (5-11 days), 2 weeks to 1 month (12-30 days), 1 to 2 months (31 to 60 days), 2 to 4 months (61 to 120 days), and 4 to 8 months (121 to 240 days) postpartum). Surprisingly, the results of this study indicated that that up to 1 month, more particularly up to 2 weeks, postpartum, there is a difference in the mean iodine concentration in HM depending on the delivery mode of the mother's infant i.e. whether the infant was born by C-section or vaginally. Further details of the study, analysis techniques and results are given in example 1.

Based on the findings of the study, the inventors have designed delivery mode specific synthetic nutritional compositions for infants up to 1 month, more particularly up to 2 weeks, of age wherein, the iodine concentration is adapted based on that found in HM produced for an infant born by the same delivery mode i.e. By C-section or Vaginally.

The term “delivery mode specific synthetic nutritional composition” as used herein refers to any synthetic nutritional composition, intended to be consumed by an infant that is specifically adapted to the nutritional needs of an infant born by a particular delivery mode .e.g. C-section or Vaginal delivery.

Non limiting examples of delivery mode specific synthetic nutritional compositions for infants from birth to 4 months include; infant formulae, and a composition for infants that is intended to be added or diluted with HM e.g. HM fortifier. Non limiting examples of delivery mode specific synthetic nutritional compositions for infants from 4 months to 12 months include infant formulae, a composition for infants that is intended to be added or diluted with HM e.g. HM fortifier, or food stuffs intended for consumption by infants either alone or in combination with HM e.g. complementary foods.

The term “infant” as used herein refers to a male or female human infant of 12 months of age or less.

In a first aspect of the invention there is provided a delivery mode specific synthetic nutritional composition for an infant up to 1 month of age, more particularly up to 2 weeks of age, wherein, the iodine concentration is adapted based on that found in HM produced for an infant born by the same delivery mode.

The delivery mode specific synthetic nutritional composition can be a C-section specific synthetic nutritional composition or a vaginal delivery specific synthetic nutritional composition for an infant up to 1 month of age, more particularly up to 2 weeks of age.

In an embodiment the delivery mode specific synthetic nutritional composition is a C-section specific synthetic nutritional composition for an infant of up to 1 month of age, more particularly up to 2 weeks of age, and comprises iodine in a concentration of 63.9 to 969.7, 127.5 to 969.7, 127.5 to 680.3, 184.7 to 515.1, 348 to 350 μg/kg.

In an embodiment the delivery mode specific synthetic nutritional composition is a vaginal delivery specific synthetic nutritional composition for an infant of up to 1 month of age, more particularly up to 2 weeks of age, and comprises iodine in a concentration of 54.2 to 598, 54.2 to 495.1, 108.7 to 366.3, 237.5 to 220.6 μg/kg.

The concentration of iodine can be measured by methods well known in the art. In particular its concentration can be measured as set out in the modified standard of BS EN 15111:2007 which is herein incorporated by reference. The principles of this method is as follows:

Total iodine is extracted from the test portion of the sample with a strong alkaline reagent (tetramethylammonium hydroxide(TMAH)) at elevated temperature using a microwave digestion system (MWD), or high pressure ashing equipment (HPA) heating. After removing undissolved components, the nebulised solution is atomized and ionized in an ICP-MS instrument. The ions of iodine are:
firstly extracted from the plasma by a system of sampler and skimmer cones,
then separated in the mass spectrometer on the basis of their mass/charge ratio
finally quantified using a pulse counting detector system.

Inductively Coupled Mass Spectrometry analysis of iodine (¹²⁷I) at mass 127 is performed using potassium iodide as calibration standards and Germanium (⁷⁴Ge) as internal standard at mass 74.

Any source of iodine known to be employed in the types of synthetic nutritional compositions disclosed herein may be comprised within the delivery mode specific synthetic nutritional compositions of the invention. A particular example is potassium Iodide.

The delivery mode specific synthetic nutritional compositions of the invention can also comprise any other ingredients or excipients known to be employed in the types of synthetic nutritional compositions disclosed herein e.g. infant formula.

Non limiting examples of such ingredients include other minerals, amino acids, proteins, carbohydrates, oligosaccharides, lipids, prebiotics or probiotics, essential fatty acids, nucleotides, nucleosides, vitamins, and other micronutrients.

Non limiting examples of other minerals include sodium, calcium, phosphorus, potassium, magnesium, iron, zinc, selenium, copper, zinc, and combinations thereof.

Non limiting examples of amino acids include leucine, threonine, tyrosine, Isoleucine, arginine, alanine, histidine, isoleucine, proline, valine, cysteine, glutamine, glutamic acid, glycine, serine, arginine, lysine, methionine, phenylalanine, tryptophane, asparagine, aspartic acid, and combinations thereof.

Non limiting examples of proteins include: casein, alpha-lactalbumin, whey, soy protein, rice protein, corn protein, oat protein, barley protein, wheat protein, rye protein, pea protein, egg protein, sunflower seed protein, potato protein, fish protein, meat protein, lactoferrin, serum albumin, immunoglobins, and combinations thereof.

Non limiting examples of carbohydrates include lactose, saccharose, maltodexirin, starch, and mixtures thereof

Non limiting examples of lipids include: palm olein, high oleic sunflower oil, high oleic safflower oil, canola oil, fish oil, coconut oil, bovine milk fat, or any mixtures of the foregoing

Non limiting examples of essential fatty acids include: linoleic acid (LA), α-linolenic acid (ALA) and polyunsaturated fatty acids (PUFAs). The nutritional compositions of the invention may further contain gangliosides monosialoganglioside-3 (GM3) and disialogangliosides 3 (GD3), phospholipids such as sphingomyelin, phospholipids phosphatidylcholine, phosphatidylethanolamine, phosphatidylinositol, phosphatidylserine, and combinations of the foregoing.

None limiting examples of prebiotics include: oligosaccharides optionally containing fructose, galactose, mannose; dietary fibers, in particular soluble fibers, soy fibers; inulin; or mixtures thereof. Preferred prebiotics are fructo-oligosaccharides (FOS), galacto-oligosaccharides (GOS), isomalto-oligosaccharides (IMO), xylo-oligosaccharides (XOS), arabino-xylo oligosaccharides (AXOS), mannan-oligosaccharides (MOS), oligosaccharides of soy, glycosylsucrose (GS), lactosucrose (LS), lactulose (LA), palatinose-oligosaccharides (PAO), malto-oligosaccharides, gums and/or hydrolysates thereof, pectins and/or hydrolysates thereof, and combinations of the foregoing.

Further examples of oligosaccharide are described in Wrodnigg, T. M.; Stutz, A. E. (1999) Angew. Chem. Int. Ed. 38:827-828 and in WO 2012/069416 which is incorporated herein by reference.

Non limiting examples of probiotics include: Bifidobacterium, Lactobacillus, Lactococcus, Enterococcus, Streptococcus, Kluyveromyces, Saccharoymces, Candida, in particular selected from the group consisting of Bifidobacterium longum, Bifidobacterium lactis, Bifidobacterium animalis, Bifidobacterium breve, Bifidobacterium infantis, Bifidobacterium adolescentis, Lactobacillus acidophilus, Lactobacillus casei, Lactobacillus paracasei, Lactobacillus salivarius, Lactobacillus lactis, Lactobacillus rhamnosus, Lactobacillus johnsonii, Lactobacillus plantarum, Lactobacillus salivarius, Lactococcus lactis, Enterococcus faecium, Saccharomyces cerevisiae, Saccharomyces boulardii or mixtures thereof, preferably selected from the group consisting of Bifidobacterium longum NCC3001 (ATCC BAA-999), Bifidobacterium longum NCC2705 (CNCM I-2618), Bifidobacterium longum NCC490 (CNCM 1-2170), Bifidobacterium lactis NCC2818 (CNCM 1-3446), Bifidobacterium breve strain A, Lactobacillus paracasei NCC2461 (CNCM 1-2116), Lactobacillus johnsonii NCC533 (CNCM 1-1225), Lactobacillus rhamnosus GG (ATCC53103), Lactobacillus rhamnosus NCC4007 (CG MCC 1.3724), Enterococcus faecium SF 68 (NCC2768; NCIMB10415), and mixtures thereof.

Non limiting examples of Nucleotides include: cytidine monophosphate (CMP), uridine monophosphate (UMP), adenosine monophosphate (AMP), guanosine monophosphate (GMP), or any mixtures thereof.

Non limiting examples of vitamins and minerals include: vitamin A, vitamin B1, vitamin B2, vitamin B6, vitamin Bi2, vitamin E. vitamin K. vitamin C, vitamin D, folic acid, inositol, niacin, biotin, pantothenic acid, choline, calcium, phosphorous, iodine, iron, magnesium, copper, zinc, manganese, chloride, potassium, sodium, selenium, chromium, molybdenum, taurine, and L-carnitine. Minerals are usually added in salt form.

Other suitable and desirable ingredients of synthetic nutritional compositions, that may be employed in the delivery mode specific nutritional compositions of the invention, are described in guidelines issued by the Codex Alimentarius with respect to the type of synthetic nutritional composition in question e.g. Infant formula, HM fortifier, follow on formula, and food stuffs intended for consumption by infants e.g. complementary foods.

The delivery mode specific compositions of the invention may be prepared by methods well known in the art for preparing that type of synthetic nutritional composition e.g. infant formulae, follow on formulae, a composition for infants that is intended to be added or diluted with HM e.g. HM fortifier.

An exemplary method for preparing a delivery mode specific powdered infant formula is as follows. A protein source, carbohydrate source, and fat source may be blended together in appropriate proportions. Emulsifiers maybe included in the blend. Iodine e.g.in the form of potassium iodide and other vitamins and minerals may be added at this point (optionally in the form of a vitamin premix) but are usually added later to avoid thermal degradation. Any lipophilic vitamins, emulsifiers and the like may be dissolved into the fat source prior to blending. Water, preferably water which has been subjected to reverse osmosis, may then be mixed in to form a liquid mixture.

The liquid mixture may then be thermally treated to reduce bacterial loads. For example, the liquid mixture may be rapidly heated to a temperature in the range of about 80° C. to about 110° C. for about 5 seconds to about 5 minutes. This may be carried out by steam injection or by heat exchanger; for example a plate heat exchanger.

The liquid mixture may then be cooled to about 60° C. to about 85° C.; for example by flash cooling. The liquid mixture may then be homogenised; for example in two stages at about 7 MPa to about 40 MPa in the first stage and about 2 MPa to about 14 MPa in the second stage. The homogenised mixture may then be further cooled and any heat sensitive components such as vitamins and minerals e.g. potassium iodide (optionally in the form of a vitamin premix) may be added. The pH and solids concentration in the homogenised mixture is conveniently standardised at this point.

The homogenised mixture can be transferred to a suitable drying apparatus such as a spray drier or freeze drier and converted to powder. The powder should have a moisture concentration in less than about 3% by weight.

If it is desired probiotic(s) can be added, they may be cultured according to any suitable method and prepared for addition to the infant formula by freeze-drying or spray-drying for example. Alternatively, bacterial preparations can be bought from specialist suppliers such as Christian Hansen and Morinaga already prepared in a suitable form for addition to food products such as infant formula. Such bacterial preparations may be added to the delivery mode specific powdered infant formula by dry mixing.

The delivery mode specific compositions of the invention may also be prepared from a delivery mode neutral synthetic nutritional composition in a method comprising; measuring out an appropriate amount of said delivery mode neutral synthetic nutritional composition and mixing it with an additive and/or diluent e.g. water so as to arrive at a delivery mode specific nutritional composition in accordance with the invention.

The additive may be a delivery mode specific additive comprising Iodine in a particular concentration so that when mixed with the delivery mode neutral synthetic nutritional composition, and optionally a diluent, the resulting mixture is a delivery mode specific synthetic nutritional composition of the invention.

The term “delivery mode neutral synthetic nutritional composition” as used herein refers to any synthetic nutritional composition, intended to be consumed by an infant, the composition of which is not specifically adapted to a specific delivery mode e.g. C-section or vaginal delivery.

The delivery mode neutral synthetic nutritional composition can be prepared by methods well known in the art. For example, as laid out above in the case of a powdered infant formula.

One or more of the delivery mode specific synthetic nutritional compositions of the invention can be included in a nutritional system.

The term “nutritional system” as used herein refers to a collection of more than one synthetic nutritional composition advertised or sold as part of the same product range e.g. a collection of infant formulas sold under the same brand and adapted to the nutritional needs of infants of differing genders and/or ages and/or modes of delivery. The synthetic nutritional compositions making up the nutritional system may be packaged individually e.g. in capsules or boxes. Said packages can be sold individually, grouped together e.g. wrapped by plastic film or combined in a box, or in a combination of these two ways.

The nutritional system may comprise only delivery mode specific synthetic nutritional compositions, or it may comprise a mix of delivery mode specific and delivery mode neutral synthetic nutritional compositions. The nutritional system may also comprise gender specific and/or gender neutral synthetic nutritional compositions.

In a further aspect of the present invention there is provided a nutritional system comprising at least one of the delivery mode specific synthetic nutritional compositions of the invention.

In an embodiment the nutritional system comprises a delivery mode specific synthetic nutritional composition for an infant born by C-section of up to 1 month of age, more particularly up to 2 weeks of age, and a delivery mode specific synthetic nutritional composition for an infant born by vaginal delivery of up to 1 month of age, more particularly up to 2 weeks of age.

In an embodiment the iodine concentration in said C-section specific synthetic nutritional composition is higher than that of said vaginal delivery specific synthetic nutritional composition.

The iodine concentration in the C-section specific synthetic nutritional compositions may be higher by any amount.

In an embodiment the ratio of the iodine concentration between the C-section specific nutritional composition and vaginal delivery specific synthetic nutritional composition is 1.6:1 to 1.1:1; 1.5:1 to 1:1.

In an embodiment the C-section specific synthetic nutritional composition contains 0.01 to 400, 75 to 375, 75 to 115 μg/kg more iodine than the vaginal delivery specific synthetic nutritional composition.

In addition to that disclosed hereinabove, the referenced study further indicated that between 12 and 240 days postpartum there is no difference in the mean iodine concentration in HM depending on the delivery mode of the mother's infant i.e. whether the mother's infant was born by C-section or by a vaginal delivery.

In another embodiment the nutritional system further comprises delivery mode specific synthetic nutritional compositions for infants more than 1 month of age, in particular more than 2 weeks of age, wherein, the iodine concentration does not differ by delivery mode for infants of the same age.

In another embodiment the nutritional system further comprises delivery mode neutral specific synthetic nutritional compositions for infants more than 1 month of age, more particularly more than 2 weeks of age.

Non limiting examples of ages, or ranges thereof, more than 2 week or 1 month include: 2weeks to 1 month, 1-2mths, 2mth, 2-4mths, 3-6mths, 4-6mths, 4-8mths 6-12mths, 7-12mths.

The nutritional system may further comprise nutritional compositions for children older than 12months.

A delivery mode specific synthetic nutritional composition, and/or nutrition system comprising it, according to the invention is particularly suitable for use in a method of preparing single servings of infant formula using capsules, each capsule of which contains a unit dose of a synthetic nutritional composition in concentrated form, and which is equipped with opening means contained within the capsule to permit draining of the reconstituted synthetic nutritional composition directly from the capsule into a receiving vessel such as a baby bottle. Such a method is described in WO2006/077259.

The different synthetic nutritional compositions, including delivery mode specific and delivery mode neutral synthetic nutritional compositions, which may be comprised within a nutrition system, may be packed into individual capsules and presented to the consumer in multipacks containing a sufficient number of capsules to meet the requirements of an infant of a particular age or age range for one week for example. Suitable capsule constructions are disclosed in WO2003/059778.

The capsules can contain the synthetic nutritional compositions, (delivery mode specific and delivery mode neutral) in the form of powders or concentrated liquids in both cases for reconstitution by an appropriate amount of water. Both the composition and the quantity of infant formula in the capsules may vary according to how the infant was born i.e. by delivery mode. If necessary, different sizes of capsules may be provided for the preparation of infant formulas for infants born by different delivery modes and/or of different ages and/or different genders.

The delivery mode specific synthetic nutritional compositions, or nutritional systems comprising them, better reflect the differences in the iodine concentration in HM found depending on the delivery mode of the mother's infant at one or more stages of lactation. As stated herein, optimum iodine intake helps to ensure the optimum growth and development e.g. physical growth and cognitive development, of an infant for example by optimizing the metabolic rate and preventing or treating goiter, hypothyroidism and hyperthyroidism.

In another aspect of the present invention there is provided a delivery mode specific synthetic nutritional composition and/or nutritional system as disclosed herein for use to treat, prevent or mitigate sub optimal growth of an infant e.g. obesity.

A delivery mode specific synthetic nutritional composition may provide an optimum amount of iodine to an infant up to 1 month of age, more particularly up to 2 weeks of age.

The nutritional system may provide an optimum amount of Iodine to an infant up to 12 months of age, up to 9 months of age, up to 8 months of age, up to 6 months of age, up to 1 month of age, up to 2 weeks of age.

In another aspect of the present invention there is provided a method for providing an optimum amount of iodine to an infant of up to 1 month of age, more particularly up to 2 weeks of age comprising:
a) Optionally preparing a delivery mode specific synthetic nutritional compositions according to the invention from a delivery mode neutral synthetic nutritional composition;
b) Feeding a delivery mode specific synthetic nutritional compositions according to the invention to an infant up to 1 month of age, more particularly up to 2weeks of age.

As stated herein. The delivery mode specific synthetic nutritional compositions may be prepared from delivery mode neutral synthetic nutritional compositions. Accordingly, in another aspect of the present invention there is provided a kit for providing an optimized amount of iodine to an infant of up to 1 month of age, more particularly up to 2 week of age, the kit comprising:
a) A delivery mode neutral synthetic nutritional composition
b) A label indicating dosage requirements for an infant so as to arrive at a delivery mode specific nutritional composition in accordance with the invention.

The dosage requirements may be with respect to the quantity of the delivery mode specific synthetic nutritional employed and/or consumption frequency e.g. 4 times per day.

Subjects included in the survey referenced herein were recruited from 4 provinces across China. Accordingly, the delivery mode specific synthetic nutritional compositions and/or nutritional systems disclosed herein can be particularly relevant for Chinese infants, and or infants born in populations having common genetic origins and/or ethnic origins and/or common dietary habits thereto e.g. Asian, Indian, and/or Mongoloid populations e.g. Han ethnic.

It should be appreciated that all features of the present invention disclosed herein can be freely combined and that variations and modifications may be made without departing from the scope of the invention as defined in the claims. Furthermore, where known equivalents exist to specific features, such equivalents are incorporated as if specifically referred to in this specification.

There now follows a series of non-limiting examples that serve to illustrate the invention.

### EXAMPLES

The iodine concentration in HM samples collected from mothers to infants delivered by either vaginal delivery or C-section was analysed at various stages postpartum. The HM samples were collected as part of a cross sectional survey of HM. The study criteria is set out below.

Study Population

The cross-sectional survey was conducted in three cities of China (Beijing, Suzhou and Guangzhou). In Beijing, Suzhou and Guangzhou there were 150, 146 and 148 healthy lactating mothers respectively, at different lactation stages(within 5-11 days, 12-30 days, 31 -60 days, 61-120 days and 121-240 days postpartum respectively) enrolled from 6 randomly selected maternal and child health hospitals. A total of 444 mothers were involved.

Inclusion/Exclusion Criteria

Inclusion: Healthy mothers were included with the following criteria:(a) without diabetes, hypertension or other chronic and acute diseases, (b) at the age of 18-45 years old, (c) full term delivery (d) single birth with a healthy baby, (e) without nipple or lacteal gland diseases.

Exclusion: Mothers were excluded if (a) they had used hormones in the previous three months, (b) if they had a history of postpartum depression or other mental disease.

Medical records and physical examination (blood pressure and fast blood glucose testing) were used to recruit the healthy mothers prior to milk collection. Height and weight were obtained to calculate the body mass index (BMI). According to the Chinese BMI, BMI<18.5, 18.5-23.9, 24-27.9 and ≧28 are defined as underweight, normal weight, overweight, and obesity respectively.

Ethics

This study was conducted according to the guidelines laid down in the Declaration of Helsinki. Written informed consent forms were obtained from all the women and all procedures involving participants were approved by the Medical Ethics Research Board of Peking University (NO.IRB00001052-11042).

Milk collection

All the lactating mothers were instructed to empty one side of their breasts at 6-7 a.m, and fed their babies using another side of breasts until formal collection. Before collecting milk, the breasts of the subjects were warmed by hot towel. Then, at 9-11 a.m., the full milk of one side of the breasts (which was emptied before) was collected by trained investigators using an electric breast pump (Horigen HNR/X-2108ZB, Xinghe Electrical Apparatuses Co., Ltd, Guangzhou, China). Fore and hind milk were gently mixed and a total of 20 mL of it was kept in frozen tubes then stored at −80° C. before testing.

Iodine Analysis

lodine(I) was tested according to the modified standard of BS EN 15111:2007. Briefly, samples were digested in closed vessels in a microwave oven with a mixture of nitric acid, de-ionized water and hydrogen peroxide. Afterwards, the digested solution was diluted with de-ionized water directly. ICP-MS was also used for testing iodine with internal standard calibration. The analytic machine used for testing was Agilent 7500cx ICP-MS (Agilent Technologies, Santa Clara, Calif., USA).

Certified samples of GBW10017 and NIST1548a-NIST were used for quality control, which were made by the Chinese National Standard Center and National Institute of Standards and Technology of America, respectively. The duplicated samples and blank assay were also made for quality control.

The results of the compositional analysis of the HM survey, with respect to the concentration of iodine are shown in table I.

Following the analysis of the iodine concentration in the HM samples non-parametric (Mann-Whitney) was used to measure the influence of the delivery mode on the iodine concentration in breast milk after adjusting the lactation stages.

A P-value inferior to 0.1, particularly 0.05, for a particular timeframe suggests that there is a statistically significant difference in the iodine mean concentration in HM produced for infants depending on their mode of delivery i.e. C-section or vaginal delivery.

As can be seen from the results in table I, a statistically significant difference in the mean iodine concentration between HM produced for infants born by C-section and by vaginal delivery was identified at 5 to 11 days postpartum. No statistically significant difference was identified in the mean concentration of iodine in HM produced for infants born by different delivery modes i.e. C-section or vaginally after 2 weeks postpartum Viz. 12 to 30 days, 1 to 2 months, 2 to 4 months and 4 to 8 months.

TABLE I
Iodine concentration μg/kg

| | | Delivery Ways | | | | | | | | |
|---|---|---|---|---|---|---|---|---|---|---|
| Lactation | | C-Section | | | | Vaginal Delivery | | | | |
| stages | | Mean ± S.D | Min | Median | Max | Mean ± S.D | Min | Median | Max | P |
| 5-11 | days | 349.9 ± 165.2 (39) | 127.5 | 348.8 | 969.7 | 237.5 ± 128.8 (43) | 54.2 | 220.6 | 598.0 | <0.001 |
| 2-30 | days | 214.3 ± 134.2 (43) | 63.9 | 173.3 | 633.5 | 229.1 ± 111.5 (38) | 65.0 | 208.6 | 549.8 | 0.173 |
| 31-60 | days | 191.1 ± 78.6 (50) | 58.6 | 199.4 | 400.0 | 248.1 ± 348.2 (31) | 51.8 | 164.7 | 688.5 | 0.580 |
| 61-120 | days | 156.6 ± 59.5 (35) | 51.6 | 161.2 | 386.5 | 275.0 ± 438.4 (50) | 54.5 | 172.4 | 496.1 | 0.076 |
| 120-240 | days | 197.5 ± 106.1 (35) | 59.0 | 165.8 | 507.2 | 183.6 ± 90.9 (49) | 62.8 | 162.8 | 582.1 | 0.710 |

Non parametric test (Mann-Whitney) was used

### Example 2

Examples of delivery mode specific infant formulas are given in table II

TABLE II

| | Up to 2 weeks | | | |
|---|---|---|---|---|
| | of age | | Up to one month | |
| | | Vaginal | of age | |
| | C-Section | delivery | C-Section | Vaginal delivery |
| Ingredients | Per Litre | | Per Litre | |
| Energy (kcal) | 670 | 670 | 670 | 670 |
| Protein (g) | 10.8 | 10.8 | 10.8 | 10.8 |
| Fat (g) | 35.7 | 35.7 | 35.7 | 35.7 |
| Linoleic acid | 5.3 | 5.3 | 5.3 | 5.3 |
| (g) | | | | |
| α-Linolenic acid | 675 | 675 | 675 | 675 |
| (mg) | | | | |
| Lactose (g) | 74.7 | 74.7 | 74.7 | 74.7 |
| Prebiotic (100% | 4.3 | 4.3 | 4.3 | 4.3 |
| GOS) (g) | | | | |
| Minerals (g) | 2.5 | 2.5 | 2.5 | 2.5 |
| Na (mg) | 150 | 150 | 150 | 150 |
| K (mg) | 590 | 590 | 590 | 590 |
| Cl (mg) | 430 | 430 | 430 | 430 |
| Ca (mg) | 410 | 410 | 410 | 410 |
| P (mg) | 210 | 210 | 210 | 210 |
| Mg (mg) | 50 | 50 | 50 | 50 |
| Mn (μg) | 50 | 50 | 50 | 50 |
| Se (μg) | 13 | 13 | 13 | 13 |
| Vitamin A (μg | 700 | 700 | 700 | 700 |
| RE) | | | | |
| Vitamin D (μg) | 10 | 10 | 10 | 10 |
| Vitamin E (mg | 5.4 | 5.4 | 5.4 | 5.4 |
| TE) | | | | |
| Vitamin K1 | 54 | 54 | 54 | 54 |
| (μg) | | | | |
| Vitamin C (mg) | 67 | 67 | 67 | 67 |
| Vitamin B1 | 0.47 | 0.47 | 0.47 | 0.47 |
| (mg) | | | | |
| Vitamin B2 | 1 | 1 | 1 | 1 |
| (mg) | | | | |
| Niacin (mg) | 6.7 | 6.7 | 6.7 | 6.7 |
| Vitamin B6 | 0.5 | 0.5 | 0.5 | 0.5 |
| (mg) | | | | |
| Folic acid (μg) | 60 | 60 | 60 | 60 |
| Pantothenic acid | 3 | 3 | 3 | 3 |
| (mg) | | | | |
| Vitamin B12 | 2 | 2 | 2 | 2 |
| (μg) | | | | |
| Biotin (μg) | 15 | 15 | 15 | 15 |
| Choline (mg) | 67 | 67 | 67 | 67 |
| Fe (mg) | 8 | 8 | 8 | 8 |
| I (μg) | 349 | 221 | 349 | 221 |
| Cu (mg) | 0.4 | 0.4 | 0.4 | 0.4 |
| Zn (mg) | 5 | 5 | 5 | 5 |

### Example 3

An example of a nutritional system in accordance with the invention is given in table III.

TABLE III

| | Up to two weeks | | 2 weeks to |
|---|---|---|---|
| | of age | | 1 month of age |
| | C-Section | Vaginal delivery | Delivery mode neutral |
| Ingredients | Per Litre | | Per Litre |
| Energy (kcal) | 670 | 670 | 670 |
| Protein (g) | 10.8 | 10.8 | 9.1 |
| Fat (g) | 35.7 | 35.7 | 35.7 |
| Linoleic acid | 5.3 | 5.3 | 5.3 |
| (g) | | | |
| α-Linolenic acid | 675 | 675 | 675 |
| (mg) | | | |
| Lactose (g) | 74.7 | 74.7 | 74.7 |
| Prebiotic (100% | 4.3 | 4.3 | 4.3 |
| GOS) (g) | | | |
| Minerals (g) | 2.5 | 2.5 | 2.5 |
| Na (mg) | 150 | 150 | 150 |
| K (mg) | 590 | 590 | 590 |
| Cl (mg) | 430 | 430 | 430 |
| Ca (mg) | 410 | 410 | 410 |
| P (mg) | 210 | 210 | 210 |
| Mg (mg) | 50 | 50 | 50 |
| Mn (μg) | 50 | 50 | 50 |
| Se (μg) | 13 | 13 | 13 |
| Vitamin A (μg | 700 | 700 | 700 |
| RE) | | | |
| Vitamin D (μg) | 10 | 10 | 10 |
| Vitamin E (mg | 5.4 | 5.4 | 5.4 |
| TE) | | | |
| Vitamin K1 | 54 | 54 | 54 |
| (μg) | | | |
| Vitamin C (mg) | 67 | 67 | 67 |
| Vitamin B1 | 0.47 | 0.47 | 0.47 |
| (mg) | | | |
| Vitamin B2 | 1 | 1 | 1 |
| (mg) | | | |
| Niacin (mg) | 6.7 | 6.7 | 6.7 |
| Vitamin B6 | 0.5 | 0.5 | 0.5 |
| (mg) | | | |
| Lactoferrin | 1 | 1 | 1 |
| (bovine) g | | | |
| Folic acid (μg) | 60 | 60 | 60 |
| Pantothenic acid | 3 | 3 | 3 |
| (mg) | | | |
| Vitamin B12 | 2 | 2 | 2 |
| (μg) | | | |
| Biotin (μg) | 15 | 15 | 15 |
| Choline (mg) | 67 | 67 | 67 |
| Fe (mg) | 8 | 8 | 8 |
| I (μg) | 349 | 221 | 209 |
| Cu (mg) | 0.4 | 0.4 | 0.4 |
| Zn (mg) | 5 | 5 | 5 |

1. A delivery mode specific synthetic nutritional composition for an infant up to 1 month of age wherein, the concentration of iodine is adapted based on that found in human milk produced for an infant of the same age born by the same delivery mode.

2. A delivery mode specific synthetic nutritional composition according to claim 1 wherein the delivery mode is C-section.

3. A delivery mode specific synthetic nutritional composition according to claim 1 wherein the delivery mode is vaginal delivery.

4. A delivery mode specific synthetic nutritional composition according to claim 2 comprising iodine in a concentration of 63.9 to 969.7 μg/kg.

5. A delivery mode specific synthetic nutritional composition according to claim 3 comprising iodine in a concentration of 54.2 to 598 μpg/kg.

6. A composition according to claim 1 wherein, the delivery mode specific synthetic nutritional composition is selected from the groups consisting of: infant formula, and a composition for infants that is intended to be added to or diluted with human milk.

7. A method of preparing a delivery mode specific nutritional composition comprising: measuring out an appropriate amount of a delivery mode neutral synthetic nutritional composition and mixing it with a diluent and/or additive to provide the delivery mode specific synthetic nutritional composition for an infant up to 1 month of age wherein, the concentration of iodine is adapted based on that found in human milk produced for an infant of the same age born by the same delivery mode.

8-11. (canceled)

12. A method to provide an optimum amount of iodine to an infant of up to 1 month of age comprising administering a specific synthetic nutritional composition comprising a concentration of iodine is adapted based on that found in human milk produced for an infant of the same age born by the same delivery mode.

13. The method of claim 12 for use to treat, protect or mitigate sub optimal growth and development of an infant.

14. A method for use in treating, protecting or mitigating sub optimal growth and development of an infant of up to 1 month of age comprising:
a. preparing a delivery mode specific synthetic nutritional compositions for an infant up to 1 month of age wherein, the concentration of iodine is adapted based on that found in human milk produced for an infant of the same age born by the same delivery mode;
b. Feeding the delivery mode specific synthetic nutritional compositions to an infant of up to 1 month of age.

15. (canceled)

16. A kit for providing an optimized amount of iodine to an infant up to 1 month of age, the kit comprising:
a. A delivery mode neutral synthetic nutritional composition
b. A label indicating dosage requirements for an infant born by a particular delivery mode so as to arrive at a delivery mode specific synthetic nutritional composition for an infant up to 1 month of age wherein, the concentration of iodine is adapted based on that found in human milk produced for an infant of the same age born by the same delivery mode.
